(19) United States
(12) Patent Application Publication
(10) Pub. No.: US 2015/0166408 A1
(43) Pub. Date: Jun. 18, 2015

(54) ALUMINOUS CEMENTS USING COAL FLY ASH

(71) Applicant: Macael, Inc., Los Angeles, CA (US)

(72) Inventors: Eric P. Bescher, Los Angeles, CA (US); Edward K. Rice, Los Angeles, CA (US); Grant M. Kao, Rowland Heights, CA (US)

(21) Appl. No.: 14/629,885

(22) Filed: Feb. 24, 2015

Related U.S. Application Data
(63) Continuation-in-part of application No. 14/487,949, filed on Sep. 16, 2014.
Application No. 14/487,949 is a continuation of application No. 13/281,241, filed on Oct. 25, 2011, now abandoned.
(60) Provisional application No. 61/406,495, filed on Oct. 25, 2010.

(51) Int. Cl. C04B 7/32; B29C 39/00

(52) U.S. Cl. CPC C04B 7/323; B29C 39/003; B29K 2105/251

(57) ABSTRACT

Addition of coal fly ash to calcium sulfoaluminate rapid-setting cements can lead to significant improvement and optimization of its properties. The addition of coal fly ash led to increased compressive strength and freeze-thaw durability while decreasing shrinkage and autoclave expansion. The presence of a super plasticizing agent negatively affected both compressive strength and shrinkage when used in combination with fly ash.

### CROSS-REFERENCE TO RELATED APPLICATIONS

This application is a Continuation-in-Part of U.S. patent application Ser. No. 14/487,949 filed Sep. 16, 2014 and now pending, which is a Continuation of U.S. patent application Ser. No. 13/281,241 filed Oct. 25, 2011, and now abandoned, which claims the benefit of U.S. Provisional Patent Application No. 61/406,495 filed Oct. 25, 2010, now expired. These applications are incorporated herein by reference.

### BACKGROUND OF THE INVENTION

1. Field of the Invention

The present invention relates to use of fly ash as a filler material in calcium sulfoaluminate cement and concrete to optimize compressive strength, shrinkage, freeze thaw resistance, and autoclave expansion.

Fly ash is the byproduct from coal-fired electric generating plants formed during the combustion of coal. Fly ash is the fine particulate matter that rises with the exhaust gasses during the combustion process. This suspended particulate matter is termed fly ash and the remaining ash left over is referred to as bottom ash. Up until the mid-1960s, fly ash was simply vented into the atmosphere until the Federal Clean Air Act was amended, regulating these types of emissions. With collection of these particles now being mandated, large amounts of fly ash began accumulating. Small quantities of this waste product began being used as cheap filler in cement and concrete products.

This use of fly ash in cementitious construction materials has steadily grown over the past several decades. However, despite this increased utilization, 60% of the generated fly ash currently produced is being disposed of in landfills. And from current production and utilization data, production of fly ash is outgrowing its use. In 2009, 63 million tons of fly ash were produced in the United States.

Different types of coal generate different types of fly ash with different chemical compositions, causing different chemical reactions with cement. Due to the varying compositions and increasing use of fly ash in the cement and concrete industries, the American Society for Testing and Materials (ASTM) included a specification for fly ash. The ASTM specification covers coal fly ash as well as other natural Pozzolan for the use in cement, designating two classes of coal fly ash: Class F and Class C. This specification sets requirement for minimum and maximum chemical content of SiO₂, Al₂O₃, Fe₂O₃, and SO₃ as well as maximum values for physical properties such as fineness. Class F fly ash is said to be rarely cementitious when mixed with water alone, while Class C fly ash is said to have cementitious properties. As used here the term coal fly ash or fly ash means a fly ash resulting from burning coal.

Generally, fly ash particles are made of spherical particles called cenospheres. The characteristics of these particles is especially relevant to the present invention, as it has been observed that when fly ash is mixed with calcium sulfoaluminate (CSA) cement, the hydration product of the CSA cement, namely, ettringite needles, attach themselves to the surface of the cenospheres, forming heretofore never observed microstructures that are believed to increase the strength of the cement through improved organization of the cement hydration products. Without wishing to be bound by this theory, these unique microstructures are certainly unique to CSA/fly ash cements and appear to play a role in early strength gain of the cement, mortar or concrete.

These unusual microstructures can be observed via electronic microscopy or other techniques. X-Ray diffraction indicates they may play a catalytic effect in the formation of ettringite in the cement.

Before federally mandated regulation and collection of fly ash was instituted, small quantities of fly ash were being collected in the United States and studied in the early 1930s. The U.S. Bureau of Reclamation approved the first major use of fly ash in ordinary Portland cement (OPC) in 1948 with the construction of the Hungry Horse Dam. This project used 120,000 tons of fly ash, replacing 30% of the cement with inexpensive waste material. Besides the cost benefit of using less cement, the project also was able to cut costs associated with cooling the concrete. As cement sets, heat is released in the reaction. The thick walls of the dam compact this heat, making it necessary to cool the cement to prevent failure of the material. Adding fly ash reduced this accumulation of heat in the concrete walls and allowed for fewer water-cooling pipes to be installed. The construction of this dam with such large percentages of fly ash was the first real proving ground for the wide-scale use of this new material.

Other beneficial properties of fly ash were later recognized. One of these other advantages of using fly ash was an increase in ultimate compressive strength. When certain fly ash was used, equivalent strengths were obtained compared to cement samples containing no fly ash at ages less than 90 days. In addition, the ultimate strengths of these samples were higher compared to the ultimate strength of the neat cement samples. Obtaining equivalent earlier strengths while using less cement was (and still is) extremely economical, considering fly ash is appreciably less expensive than OPC. Many state and federal departments of transportation now use and encourage use of fly ash in the construction of new roads and highways. Up until now, however, the addition of fly ash to modify such properties has only been carried out in OPC.

### BRIEF DESCRIPTION OF THE DRAWINGS

FIG. 1 is a scanning electron microscope image of the cement paste without the super plasticizer.

FIG. 2 is a scanning electron microscope image of the cement paste with the super plasticizer.

FIG. 3 is the quantitative x-ray analysis of the formation of ettringite.

FIG. 4 is a graph showing shrinkage from the addition of fly ash without a super plasticizer.

FIG. 5 is a graph showing shrinkage from the addition of fly ash with a super plasticizer.

### DETAILED DESCRIPTION

Even though fly ash has been used in the past to achieve greater strength in OPC, the chemistry involved in calcium sulfoaluminate (CSA) cement is entirely different. The mechanism for early strength development in CSA cements is very different from that of OPC cement and as a result, the microstructures of the cements are completely different. OPC does not gain appreciable compressive strength for 3 days while CSA cement may achieve 6,000 psi with one hour of hydration under the appropriate protocols. This early strength is due to the formation of ettringite, a phase which is not present in OPC. In the present cement, the formation of novel microstructures based on ettringite and fly ash is observed. Whereas the true increase in compressive strength associated with OPC cement comes at late stages of hydration, usually 90 days or later. This compressive strength increase in OPC cement is largely associated with the reduction of water due to the spherical shape of the fly ash particles.

Testing Protocols used in this Application

Autoclave expansion: a standard test method using ASTM C151 to index the potentially delayed expansion caused by the hydration of calcium oxide, magnesium oxide, or both, in hydraulic cement.

Compressive strength: the physical property obtained through ASTM C109 which is the standard test method for determining compressive strength of hydraulic cement mortars.

Freeze—thaw resistance: the physical property obtained through ASTM C666 which is the standard test method for determining the resistance of concrete to rapid freezing and thawing.

Setting time: the physical property obtained through ASTM C191 which is the standard test method for determining the interval of time between initial hydration of the cement and the time when the mix is no longer workable.

Shrinkage: the physical property obtained through ASTM C157 which is the standard test method for determining the length change of hardened hydraulic cement, mortar, and concrete during curing.

Acronyms used in this Application

CSA: Calcium sulfoaluminate.

OPC: Ordinary Portland cement.

w/c: Water-to-cement ratio.

### EXAMPLE 1

### Compressive Strength (Fly Ash)

The compressive strength increase observed with the addition of fly ash was tested using standard 2-inch mortar cubes using ASTM C109 protocol. Two different types of fly ash were used—Class F and Class C fly ash with the composition of each fly ash shown in Table 1, which displays the chemical analysis of the two different types of fly ash. (Values in weight percent.)

TABLE 1

| Class | SiO₂ | Al₂O₃ | Fe₂O₃ | CaO | MgO | SO₃ | Na₂O | K₂O | L.O.I. |
|---|---|---|---|---|---|---|---|---|---|
| F | 59.20 | 23.53 | 5.04 | 5.68 | 1.00 | 0.25 | 0.00 | 0.00 | 0.92 |
| C | 41.16 | 16.26 | 7.02 | 26.03 | 5.58 | 2.86 | 0.00 | 0.00 | 1.35 |

Two general mix designs were used, one without the presence of a melamine based super plasticizing agent (Table 2, which displays the mix designs for the samples without the super plasticizer) and one with the presence of the super plasticizer (Table 3, which displays the mix designs for the samples with the super plasticizer). In the tables below RS Cement is CSA cement.

TABLE 2

| | | Fly Ash | Super P | RSC | Sand |
|---|---|---|---|---|---|
| Mix Design | w/c | (grams) | (grams) | (grams) | (grams) |
| 100% RS Cement | 0.4 | 0 | 0 | 1000 | 1000 |
| 90% RS Cement + 10% | 0.4 | 100 | 0 | 900 | 1000 |
| Fly Ash | | | | | |
| 80% RS Cement + 20% | 0.4 | 200 | 0 | 800 | 1000 |
| Fly Ash | | | | | |
| 70% RS Cement + 30% | 0.4 | 300 | 0 | 700 | 1000 |
| Fly Ash | | | | | |

TABLE 3

| | | Fly Ash | Super P | RSC | Sand |
|---|---|---|---|---|---|
| Mix Design | w/c | (grams) | (grams) | (grams) | (grams) |
| 100% RS Cement | 0.4 | 0 | 18.0 | 982.0 | 1000 |
| 90% RS Cement + 10% | 0.4 | 98.2 | 18.0 | 883.8 | 1000 |
| Fly Ash | | | | | |
| 80% RS Cement + 20% | 0.4 | 196.4 | 18.0 | 785.6 | 1000 |
| Fly Ash | | | | | |
| 70% RS Cement + 30% | 0.4 | 294.6 | 18.0 | 687.4 | 1000 |
| Fly Ash | | | | | |

The particular super plasticizer used in this experiment was Melment F10. The water-to-cement ratio (w/c) for all samples was 0.40. The rapid-setting cement was replaced with fly ash of 10, 20, and 30 weight percent. Each of the fourteen mix designs was tested at 1.5, 3.0, and 24 hours after initial hydration. Looking at the samples without a super plasticizer (Table 4, which displays the compressive strength values for the cubes without the super plasticizer), the samples had an increase in compressive strength when compared to the witness sample.

TABLE 4

| | | | | 1.5 | | |
|---|---|---|---|---|---|---|
| | Fly ash | | | Hour | 3.0 Hour | 24 Hour |
| | (weight | Initial Set | Final Set | Strength | Strength | Strength |
| | %) | (minutes) | (minutes) | (psi) | (psi) | (psi) |
| Witness | 0 | 15 | 18 | 5203 | 5702 | 7518 |
| Class F | 10 | 13 | 15 | 4980 | 6388 | 6545 |
| | 20 | 11 | 20 | 5695 | 7352 | 8568 |
| | 30 | 11 | 19 | 5512 | 6677 | 6955 |
| Class C | 10 | 12 | 16 | 5505 | 6298 | 7883 |
| | 20 | 10 | 13 | 5475 | 6542 | 5163 |
| | 30 | 9 | 15 | 5507 | 6520 | 7758 |

However, when looking at the samples with a super plasticizer (Table 5, which displays the compressive strength values for the cubes with the super plasticizer), the samples had a decrease in compressive strength compared to the witness sample.

TABLE 5

| | | | | 1.5 | | |
|---|---|---|---|---|---|---|
| | Fly ash | | | Hour | 3.0 Hour | 24 Hour |
| | (weight | Initial Set | Final Set | Strength | Strength | Strength |
| | %) | (minutes) | (minutes) | (psi) | (psi) | (psi) |
| Witness | 0 | 26 | 34 | 5807 | 6747 | 7928 |
| Class F | 10 | 24 | 27 | 5932 | 6570 | 7263 |
| | 20 | 25 | 33 | 5027 | 5093 | 7372 |
| | 30 | 21 | 30 | 4873 | 6155 | 7330 |
| Class C | 10 | 20 | 26 | 5210 | 5787 | 6740 |
| | 20 | 13 | 19 | 5182 | 5748 | 6977 |
| | 30 | 11 | 19 | 4912 | 5685 | 7137 |

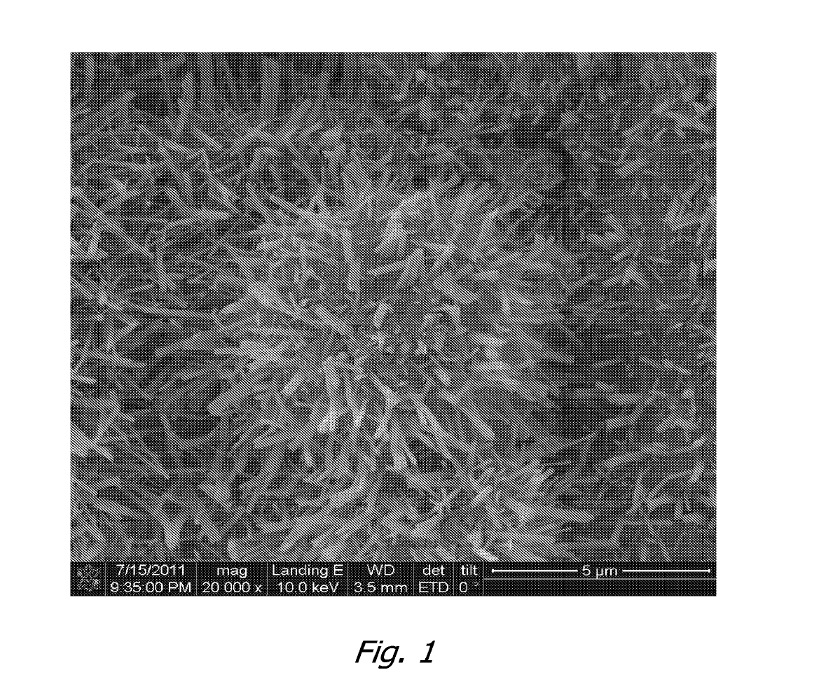

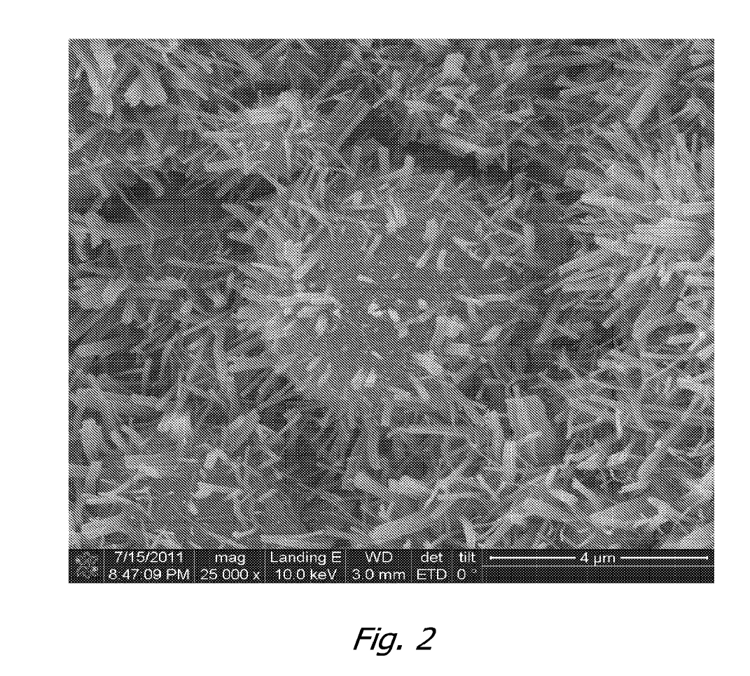

The mechanism believed to produce the additional strength with fly ash relies on the nucleation and growth of ettringite needles on the surface of the fly ash particles (FIG. 1). The addition of a super plasticizer is believed to coat the surface of the suspended fly ash particles in the hydrated cement paste, prohibiting nucleation and growth of these structures (FIG. 2). It is believed that these structures interlock with each other, providing additional strength to the material. Inhibiting the growth of these structures will therefore lessen or negate this strengthening mechanism.

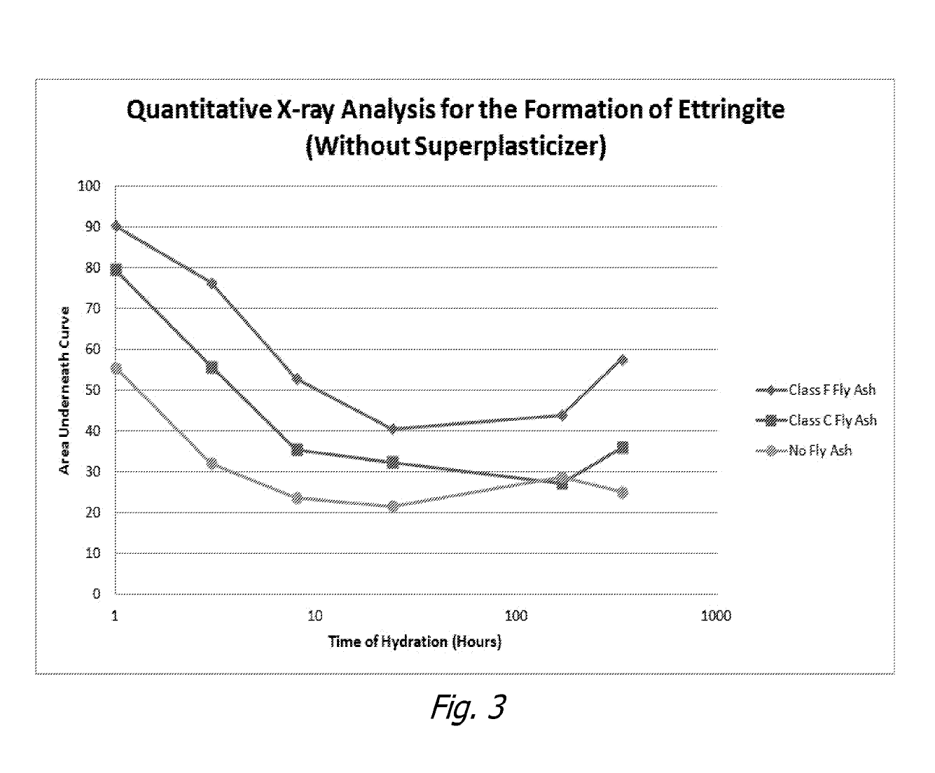

The use of x-ray diffraction was used to quantify the presence of ettringite for the various mix designs with and without the presence of a super plasticizer. When the analysis was complete, the results showed that more ettringite was formed with the witness samples than the samples containing fly ash. However, when the data was normalized to take into account the decrease in cement content, the fly ash samples were shown to contain more ettringite (FIG. 3). This normalized data suggests two important pieces of information: (1) the presence of fly ash increases the production of ettringite needles per gram of cement, and (2) the fly ash samples are achieving higher compressive strength values with less ettringite. The second statement also supports the concept that the fewer needles present in the fly ash samples are organizing themselves in a manner to increase the mechanical behavior of the material.

### EXAMPLE 4

### Shrinkage

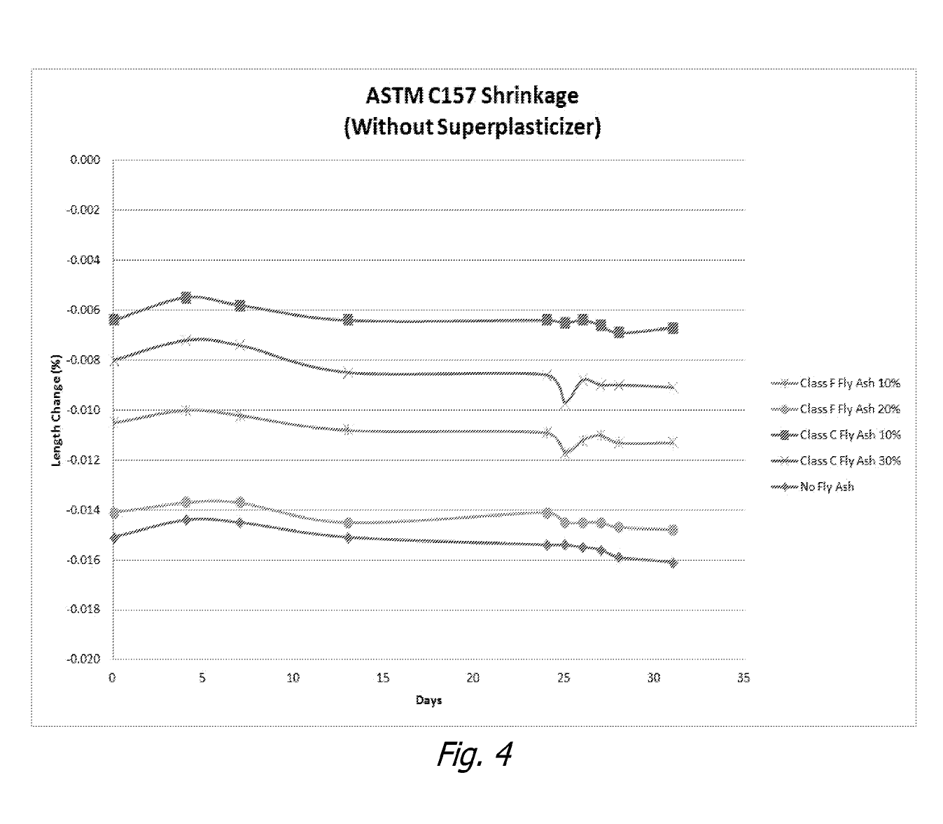

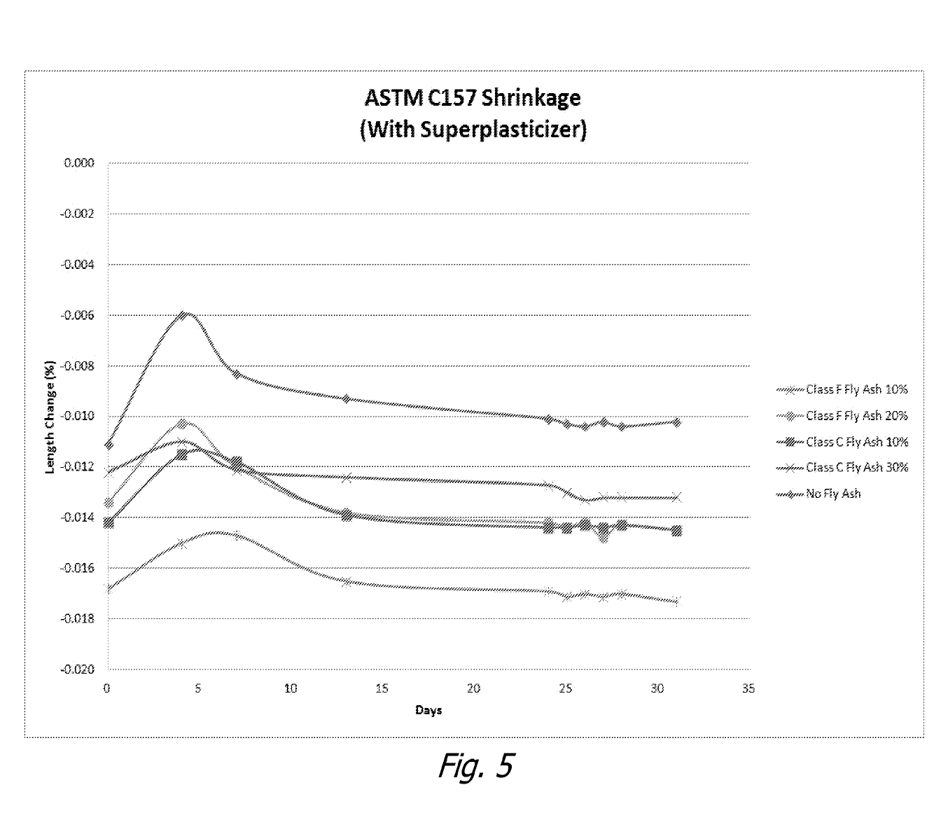

Shrinkage was tested using the ASTM C157 standard. The specimens were made using the same fly ash mix proportions listed in Tables 2 and 3 using ASTM C109 both with and without a super plasticizer. The addition of fly ash in the absence of a super plasticizer significantly lowered shrinkage in most cases, as shown in FIG. 4. However, when fly ash was added in combination with a super plasticizer, this decrease in shrinkage was no longer achieved, as shown in FIG. 5.

### EXAMPLE 5

### Autoclave Expansion

Autoclave expansion testing was conducted in accordance with the ASTM C151 standard. This test takes a neat cement sample (i.e., a CSA cement sample without fly ash) to provide results on potential delayed expansion caused by the hydration of CaO or MgO. The mix designs along with the test results are shown in Table 8, which displays autoclave with a passing/failing grade based on ASTM C151.

TABLE 8

| | Fly Ash | Cement | Fly Ash | Water | AC result |
|---|---|---|---|---|---|
| | (weight %) | (grams) | (grams) | (mL) | (+/−/F) mm |
| Witness | 0 | 400 | 0 | 132.5 | Failed |
| Class F | 10 | 360 | 40 | 132.5 | Pass, −0.021% |
| | 20 | 320 | 80 | 132.5 | Pass, −0.031% |
| | 30 | 280 | 120 | 132.5 | Pass, −0.015% |
| Class C | 10 | 360 | 40 | 132.5 | Pass, −0.050% |
| | 20 | 320 | 80 | 132.5 | Pass, −0.054% |
| | 30 | 280 | 120 | 132.5 | Pass, −0.045% |

The water was kept constant with replacements of fly ash of 10, 20, and 30%. The neat CSA cement alone did not pass the autoclave test due to high MgO content. However, the samples containing fly ash passed.

### EXAMPLE 6

### Freeze-Thaw Resistance

Freeze-thaw resistance was tested using the New York standard test method 502-3P. This standard test method is used to correlate durability of cement and concrete mixtures when exposed to alternating environments which have drastic freezing and thawing climates. Three mix designs were made for the freeze-thaw testing as shown in Table 9, which displays freeze-thaw measured in grams for each sample. (Values in weight percent.)

TABLE 9

| | | Sample A | Sample B | | Sample A | Sample B | |
|---|---|---|---|---|---|---|---|
| Mix | Solution | (grams) | (grams) | % Loss | (grams) | (grams) | % Loss |
| | | 0 Cycles | | | 6 Cycles | | |
| No Fly | NaCl | 1685.1 | 1723.5 | 0 | — | — | — |
| Ash | CaCl₂ | 1735.3 | 1724.3 | 0 | — | — | — |
| 35% Fly | NaCl | 1738.9 | 1727.5 | 0 | 1742.5 | 1730.1 | 0.18% |
| Ash | CaCl₂ | 1734.5 | 1734.4 | 0 | 1737.6 | 1738 | 0.19% |
| 40% Fly | NaCl | 1703.9 | 1703.9 | 0 | 1709.1 | 1709.4 | 0.31% |
| Ash | CaCl₂ | 1712.8 | 1705.6 | 0 | 1717.1 | 1709.5 | 0.24% |
| | | 14 Cycles | | | 25 Cycles | | |
| No Fly | NaCl | 1678.0 | 1715.9 | −0.43% | 1484.1 | 1457.3 | −13.69% |
| Ash | CaCl₂ | 1670.8 | 1689.6 | −2.86% | 1249.6 | 1424.0 | −22.70% |
| 35% Fly | NaCl | 1742.5 | 1730.0 | 0.18% | 1738.7 | 1724.2 | −0.10% |
| Ash | CaCl₂ | 1736.6 | 1737.9 | 0.16% | 1733.5 | 1735.5 | 0.00% |
| 40% Fly | NaCl | 1707.8 | 1708.2 | 0.24% | 1702.1 | 1702.5 | −0.09% |
| Ash | CaCl₂ | 1700.4 | 1707.3 | −0.31% | 1686.5 | 1703.0 | −0.84% |

All samples contained 34.18% silica sand per ASTM C33, and all samples contained 45.77% one-inch rock aggregate with a water-to-cement ratio of 0.43. At the start of the test, samples were immersed in two different solutions of calcium chloride and sodium chloride. The weight loss of each sample was measured at various cycles.

The test calls for a maximum of 25 cycles. Table 9 exhibits all the percent weight loss of each sample. At 25 cycles, samples with fly ash replacements had less than 1% weight loss from the freeze thaw cycles, showing great durability in rigorous freeze-thaw environments.

The spherical cenospheres of the coal fly ash are believed to be significant to the results achieved. Other forms of fly ash having different particle shapes may provide inferior results. The cement may consequently exclude use of some or all other forms of fly ash, or limit the amount of such other forms of fly ash to less than 1 wt. %. Preferably the fly ash used excludes heavy metals such as lead and zinc, and also excludes dioxin, or contains less than 0.1% wt. of these materials.

The CSA used may be standalone CSA or ground CSA clinker with no added components. Alternatively the CSA may be blended with OPC, with fly ash added to the blend. In either case the cement is mixed with the coal fly ash to provide a coal flay ash-containing cement. The coal fly ash-containing cement may be mixed with water to prepare a mortar or concrete, with the mixing occurring at ambient temperatures from just above freezing (32 F.+) and below 90 F. Similarly, mortars or concretes using the coal fly ash-containing cements may cure at temperatures 33 to 85 or 89 F. For example, such a concrete as used for overnight roadway repair may be poured and will cure at ambient temperatures above freezing and below 90 F.

In some applications, it may also be advantageous to exclude specific additives from the mortar or concrete prepared using the present coal fly ash-containing cement. These additives which may be excluded include organic additives, polymers, superplasticizers, alkanolamine, amino alcohols, and fibers such as glass fibers. Thus, mortars or concretes prepared using the present fly ash-containing cement may exclude one or more, or all of these additives. Similarly, equivalents of these additives may also be excluded. In view of the test results above, the mortar or concrete may contain from zero to 0.01 wt % superplasticizers, and typically has no superplasticizer.

In a method for preparing the cement, a CSA cement clinker is made using known techniques and compositions. The clinker is ground into cement powder. The cement powder is dry mixed with coal fly ash, in the proportions discussed above, to produce a coal fly ash-containing cement, which may then be used to make mortar or concrete. Concrete may be made by mixing the coal fly ash-containing cement with water, sand and aggregate, optionally at an ambient temperature above freezing and below 85 or 90 F. The concrete may then be poured to form a roadbed, slab, or other structure, with the ambient temperature above freezing (32 F.) and below 85 or 90 F. The structure may be cured by air drying, i.e., via the exposure of the structure to ambient air. The mixing and curing of the concrete may be performed without heating the concrete, if the ambient temperature is within the described limits. The concrete may contain from zero to 0.025 wt % of alkanolamine, and typically contains no alkanolamine. This same method may also be used to make mortar, by excluding the aggregate.

### Conclusions

The early compressive strength of a CSA cement can be improved by the addition of 5% to 40% fly ash of any classification (Table 3). The resulting cement passes autoclave testing due to the addition of the coal fly ash, and when tested using ASTM C 157, and exhibits a shrinkage of less than 0.02% at 28 days. Typical cements prepared as described may have 10, 15 or 20 to 35 wt % of fly ash added.

Table 4 indicates that the substitution of some rapid setting calcium sulfoaluminate cement for fly ash of any type in the 10-30 wt % range increases the 1.5 hour, 3 hr or 24 hr strength by at least 500 to 1000 psi, and can be as much as 1,500 psi.

The addition of up to 40% fly ash of any type allows a calcium sulfoaluminate-cement failing the autoclave test to pass (Table 8).

The claims of this patent include the optimization of a rapid-setting calcium sulfoaluminate cement with the controlled addition of coal fly ash,. The addition of coal fly ash led to increased compressive strength and freeze-thaw durability while decreasing shrinkage and autoclave expansion. The presence of a super plasticizing agent was shown to negatively affect both compressive strength and shrinkage when added to samples containing fly ash.

CSA-belite is a calcium sulfoaluminate (CSA) cement that contains a significant (>40% by weight) fraction of belite dicalcium silicate (C2S in chemist notation). This cement is different from other types of CSA cement which are typically made with clinker containing in excess of 50% and then blended with portland cement and/or calcium sulfate. The CSA-belite cement is a one-component cement that does not contain any portland cement. It exhibits a unique set of properties such as low shrinkage, fast setting time and high resistance to sulfate attack.

It is understood that changes in the chemical composition of the cement may lead to corresponding changes in the properties of the mortars and concrete made with such modified cement. The maximum amounts of contaminants or undesired materials, such as heavy metals, dioxin, glass fiber, organic additives, etc. may apply individually or in combination. For example, a cement, concrete or mortar may have none of one or more of these materials, or an amount of them below the specified maximums. Thus while certain preferred embodiments of the present invention have been disclosed and described herein for purposes of illustration and not for purposes of limitation, it will be understood by those skilled in the art that various changes in form and detail may be made therein without departing from the spirit and scope of the invention.

1. A rapid-setting material comprising calcium sulfoaluminate cement and coal fly ash, the amount of coal fly ash being 5 to 30% by weight of the material, and with the cement containing less than 0.025 wt % of alkanolamine.

2. The material of claim 1 wherein cement contains no measureable alkanolamine.

3. The material of claim 1 wherein the amount of coal fly ash is 10-30 wt % coal fly ash, whereby the resulting 1.5 hour, 3 hour or 24 hour compressive strength is increased by 500 to 1,000 psi compared to the strength of the pure calcium sulfoaluminate-containing cement.

4. The material of claim 1 which passes autoclave testing due to the addition of coal fly ash.

5. The material of claim 1 in which ettringite content has increased after hydration, when compared to calcium sulfoaluminate cement without coal fly ash.

6. The cement of claim 1 which, when tested using ASTM C 157, exhibits a shrinkage of less than 0.02% at 28 days.

7. The cement of claim 1 containing ettringite bonded to coal fly ash particles.

8. A rapid-setting material comprising calcium sulfoaluminate cement and coal fly ash in an amount of 5 to 30% by weight, the material containing microstructures including ettringite bonded to fly ash particles.

9. A concrete comprising:
calcium sulfoaluminate cement and coal fly ash, the amount of coal fly ash being 5 to 30% by weight of the material, sand, and aggregate, and less than 0.025 wt % of alkanolamine.

10. A method for making an object, comprising:
A] Mixing CSA cement with coal fly ash to form a coal fly ash-containing cement, with the coal fly ash comprising 5 to 30 Wt. % of the coal fly ash-containing cement;
B] Mixing the coal fly ash-containing cement with water and sand to form a composite;
C] Pouring the composite into a desired shape;
D] Curing the composite via air drying; and
E] with steps B, C and D performed at an ambient temperature of 33 to 89 F.

11. The method of claim 10 with step A also performed at an ambient temperature of 33 to 89 F.

12. The method of claim 10 wherein the temperature of the composite itself is 33 to 89 F.

13. The method of claim 12 wherein the composite contains less than 0.025 wt. % of alkanolamine.

14. The method of claim 12 wherein the composite contains less than 0.1 wt. % of each of lead, zinc and dioxin.

15. The method of claim 12 wherein the composite contains less than 0.01 wt. % of superplasticizer.

16. The method of claim 12 further including mixing aggregate into the composite in step B to form a concrete.

17. The material of claim 1 wherein the calcium sulfoaluminate cement comprises CSA-belite.

18. The material of claim 17 wherein at least 90% of the cement in the material is CSA-belite.

19. The material of claim 1 containing less than 0.025 wt. % of glass fiber.
